(19) United States
(12) Patent Application Publication
(10) Pub. No.: US 2003/0022788 A1
(43) Pub. Date: Jan. 30, 2003

(54) Ceramic catalyst body

(76) Inventors: Masakazu Tanaka, Okazaki-city (JP); Tosiharu Kondo, Toyoake-city (JP); Takashi Kondo, Kariya-city (JP); Tomomi Hase, Kariya-city (JP)

Correspondence Address: Nixon & Vanderhye P.C., 8th Floor, 1100 North Glebe Road, Arlington, VA, 22201-4714, US

(21) Appl. No.: 10/202,826

(22) Filed: Jul. 26, 2002

(30) Foreign Application Priority Data
Jul. 30, 2001 (JP) 2001-228991
Mar. 7, 2002 (JP) 2002-62010

(51) Int. Cl. B01J 23/38; B01J 31/00

(52) U.S. Cl. 502/325; 502/167

(57) ABSTRACT

The present invention provides a ceramic catalyst body having more excellent catalytic performance using a ceramic carrier capable of directly supporting the catalyst component.

A ceramic catalyst body is obtained by directly supporting a noble metal catalyst such as Pt on a ceramic carrier made by substituting at least one kind among the constituent elements of cordierite that constitutes the substrate ceramic, for example Al, with W, a compound containing no chlorine, for example dinitrodiammine platinum, is used as a starting material of the noble metal catalyst. It is then possible to prevent the residual chlorine from suppressing support of the catalyst, thereby increasing the quantity of the catalyst supported and to improve the catalyst performance.

### BACKGROUND OF THE INVENTION

1. Field of the Invention

The present invention relates to a ceramic catalyst body used as a catalyst support in an exhaust gas purifying catalyst of an automobile engine or the like.

2. Description of the Related Art

A catalyst, that is made by applying y-alumina coating on the surface of cordierite that is formed in honeycomb shape and is provided with a noble metal catalyst supported thereon, has been widely used as a catalyst support in an exhaust gas purifying catalyst. The coating layer is formed because the specific surface area of the cordierite is too small to support a required amount of catalyst component. Thus the surface area of the support is increased by using γ-alumina that has a large specific surface area.

When the surface of the support is coated with γ-alumina, however, the heat capacity of the carrier increases due to the increase in the mass. Recently investigations have been conducted to find means to decrease the heat capacity by making the cell wall of the honeycomb support thinner, in order to achieve earlier activation of the catalyst. However, the effect of this attempt is reduced by the formation of the coating layer. There have also been such problems that the coefficient of thermal expansion of the support becomes larger due to the coating layer, and the decrease in the opening area of the cell increases the pressure loss.

Various researches have been conducted to achieve ceramic bodies capable of supporting catalyst components without forming a coating layer. In Japanese Examined Patent Publication (Kokoku) No. 5-50338, for example, a method is proposed that improves the specific surface area of cordierite itself by applying heat treatment after pickling. However, this method has not been practical because acid treatment or heat treatment causes the destruction of the crystal lattice of cordierite, thus resulting in lower mechanical strength.

The present inventors have previously proposed a ceramic carrier capable of supporting a required quantity of catalyst components without forming a coating layer that improves the specific surface area (Japanese Patent Application No. 2001-82751). The ceramic carrier disclosed in Japanese Patent Application No. 2001-82751 comprises a substrate ceramic wherein one or more of elements that constitute it is substituted with an element other than the constituent elements, and a catalyst component can be directly supported on the substituting element by immersing the ceramic carrier in a solution of a noble metal compound such as hexachloroplatinic acid, platinic chloride or rhodium chloride, drying and sintering. Consequently, the resulting carrier has high strength and improved durability as compared with a conventional carrier whose vacancies are formed by an acid treatment or a heat treatment.

### SUMMARY OF THE INVENTION

An object of the present invention is to realize a ceramic catalyst body having a more excellent catalytic performance by using a ceramic carrier capable of directly supporting the catalyst component.

According to a first aspect of the present invention, the ceramic catalyst body comprises a ceramic carrier capable of supporting a catalyst component directly on the surface of a substrate ceramic and a catalyst supported on the ceramic carrier, wherein said catalyst component is made of a compound containing no chlorine in the composition as a starting material.

In the ceramic catalyst body of the present invention, the catalyst component is directly supported on the surface of the substrate ceramic and, therefore, a required quantity of the catalyst can be supported without lowering the strength. It was found that the catalyst performance is improved when using a compound containing no chlorine as a starting material of the catalyst component. The reason is as follows. That is, when using a compound containing chlorine, chlorine remains on the surface of the catalyst and suppresses the catalyst supported on the surface of the substrate ceramic or suppresses a catalytic function of the catalyst. In the present invention, removal of chlorine increases the quantity of the catalyst supported, thus making it possible to more effectively exert the catalyst performance. The catalyst can be highly dispersed because firing can be conducted at a comparatively low temperature. Consequently, it is possible to realize a high performance ceramic catalyst body which has a low heat capacity and a low pressure loss and is also excellent in durability.

Specifically, an ammine complex salt, a nitro complex salt, a nitroammine complex salt, a tetraammine complex salt, a nitrate salt or an acetate salt can be used as the compound. The effect described above can be easily obtained by using an ammine complex salt, a nitro complex salt, a nitroammine complex salt, a tetraammine complex salt, a nitrate salt or an acetate salt that does not contain chlorine.

Preferably, a noble metal is used as the catalyst component. By impregnating the ceramic carrier with a solution of the compound and firing, the catalyst component is chemically bonded with the substituting element, thereby making it possible to directly support it on the substituting element. The catalyst component can be uniformly dispersed on the surface of the ceramic carrier by using the solution.

Preferably, the content of chlorine in the solution of the compound is lower than 14.8 g/L, and the effect described above can be obtained when the content is lower than the above range. The lower the content, the higher the effect of improving the catalyst performance.

As the ceramic carrier, a carrier capable of supporting the catalyst component directly on the substituting element can be used by substituting one or more of the element that constitute the substrate ceramic is substituted with an element other than the constituent element.

In this case, the catalyst metal is preferably supported on the substituting element through chemical bonding. Chemical bonding of the catalyst metal improves the retention of the catalyst and reduces the possibility of deterioration over a long period of use as the catalyst component is evenly distributed over the carrier and is less likely to coagulate.

One or more element having a d or f orbit in the electron orbits thereof can be used as the substituting element described above. An element having d or f orbit in the electron orbits thereof has higher tendency to bond with the catalyst metal, and is therefore preferable.

The ceramic carrier has a multitude of pores capable of directly supporting the catalyst on the surface of the substrate ceramic so that the catalyst metal can be supported directly in the pores.

Specifically, the pores described above comprise at least one kind selected from the group consisting of defects in the ceramic crystal lattice, microscopic cracks in the ceramic surface and missing defects of the elements which constitute the ceramic.

The microscopic cracks are preferably 100 nm or smaller in width in order to ensure mechanical strength of the carrier.

The pores have a diameter or a width preferably 1,000 times the diameter of the catalyst ion to be supported therein or smaller, in order to be capable of supporting the catalyst metal. At this time, a quantity of catalyst metal comparable to that in the prior art can be supported when the density of pores is 1×10¹¹/L or higher.

A ceramic containing cordierite as the main component is used as the substrate ceramic, and the pores may be defects formed by substituting a part of the constituent elements of the cordierite with a metal element having different value of valence. Cordierite has high resistance against thermal shock and is therefore suitable for the catalyst to purify the automobile exhaust gas.

In this case, the defects are at least one kind, oxygen defect or lattice defect. A quantity of catalyst metal comparable to that in the prior art can be supported when the proportion of cordierite crystal containing at least one defect in a unit crystal lattice of cordierite is set to 4×10⁻⁶% or higher.

### BRIEF DESCRIPTION OF THE DRAWINGS

FIG. 1(a) is a general schematic view showing a ceramic catalyst body having a honeycomb structure of the present invention, FIG. 1(b) is an enlarged view of the portion A of FIG. 1(a), and FIG. 1(c) is an enlarged view of the portion B of FIG. 1(b).

FIG. 2(a) is a schematic view showing the state of a cell wall after impregnating a ceramic carrier with a catalyst solution and drying, FIG. 2(b) is a schematic view showing the state after firing in case of firing at 600° C. using a starting material containing chlorine, FIG. 2(c) is a schematic view showing the state after firing in case of firing at 800° C. using a starting material containing chlorine, and FIG. 2(d) is a schematic view showing the state after firing in case of firing at 600° C. using a starting material containing no chlorine.

FIG. 3 is a process drawing showing the method of producing a ceramic catalyst by supporting the catalyst metal on the ceramic carrier in the Example and the Comparative Example of the present invention.

FIG. 4 is a graph showing a relationship between the starting material of the catalyst metal and the catalyst performance in the Example and the Comparative Example of the present invention.

### DETAILED DESCRIPTION OF THE PREFERRED EMBODIMENTS

The present invention will be described in detail below. The ceramic carrier used in the present invention has a constitution that allows the catalyst component to be directly supported on the surface of the substrate ceramic without forming a coating layer made of γ-alumina. A substrate ceramic made from cordierite having theoretical composition of 2MgO.2Al₂O₃.5SiO₂ as the main component is suited for use as a substrate for ceramic. Main component of the ceramic may also be other ceramic materials such as alumina, spinel, aluminum titanate, silicon carbide, mullite, silica-alumina, zeolite, silicon nitride, and zirconium phosphate, in addition to cordierite. The shape of the ceramic body is not specifically limited and may also be other shapes such as honeycomb, foam, hollow fiber, fiber, powder or pellets.

One or more of the element that constitute the substrate ceramic of the substrate ceramic is substituted with an element other than the constituent element, and the ceramic carrier is capable of supporting the catalyst component directly on the substituting element. Alternatively, the ceramic carrier has, on the surface of the ceramic substrate, a multitude of pores that are capable of directly supporting the catalyst component. Specifically, the pores, capable of directly supporting the catalyst component, comprise at least one kind selected from the group consisting of defects in the ceramic crystal lattice (oxygen defect or lattice defect), microscopic cracks in the ceramic surface and missing defects of the elements which constitute the ceramic. It suffices that at least one kind of these pores be formed in the ceramic carrier, while two or more of kinds thereof may also be formed in combination.

First, an element capable of directly supporting the catalyst component will be described. As the element substituted with the constituent elements (for example, Si, Al and Mg in the case of cordierite) of the substrate ceramic, elements having a large bonding strength with the catalyst component as compared with these constituent elements and capable of supporting the catalyst component by means of chemical bonding are used. Specifically, the substituting elements may be one or more elements which are different from the constituent elements and have a d or an f orbit in the electron orbits thereof, and preferably have empty orbit in the d or f orbit or have two or more oxidation states. An element which has an empty orbit in the d or f orbit has energy level near that of the metal catalyst being supported, which means a higher tendency to exchange electrons and bond with the metal catalyst. An element which has two or more oxidation states also has higher tendency to exchange electrons and provides the same effect.

Specific examples of the substituting element having an empty orbit in the d or f orbit thereof include Sc, Ti, V, Cr, Mn, Fe, Co, Ni, Y, Zr, Nb, Mo, Tc, Ru, Rh, La, Ce, Pr, Nd, Pm, Sm, Eu, Gd, Tb, Dy, Ho, Er, Tm, Lu, Hf, Ta, W, Re, Os, Ir and Pt. Preferably, one or more of elements selected from Ti, V, Cr, Mn, Fe, Co, Ni, Zr, Mo, Ru, Rh, Ce, W, Ir and Pt are used. Among these elements, Ti, V, Cr, Mn, Fe, Co, Ni, Nb, Mo, Tc, Ru, Rh, Ce, Pr, Eu, Tb, Ta, W, Re, Os, Ir and Pt are elements two or more oxidation states.

Specific examples of the other element having two or more oxidation states include Cu, Ga, Ge, As, Se, Br, Pd, Ag, In, Sn, Sb, Te, I, Yb and Au. Preferably, one or more of elements selected from Cu, Ga, Ge, Se, Pd, Ag and Au are used.

When the constituent element of the substrate ceramic is substituted with these substituting elements, the proportion of the substituting element is controlled in a range from 1 to 50% of the number of atoms of the constituent element to be substituted. When one of constituent elements is substituted with plural substituting elements, the total proportion is controlled within the above range. When the proportion of substituted atoms is less than 1%, the substitution cannot produce sufficient effect. The proportion higher than 50% results in greater influence on the crystal structure of the ceramic material, and is not desirable. Preferably, the proportion is controlled in a range from 5% to 20%.

The ceramic carrier, wherein a portion of constituent elements of the substrate ceramic is substituted, of the present invention is produced, for example, by previously subtracting a portion of starting materials of constituent elements to be substituted according to the proportion to be substituted to prepare starting materials of ceramic, kneading the mixture, forming the kneaded, mixture and drying the preform using a conventional method, and immersing in a solution containing substituting elements. The preform, having many substituting elements on the surface, was taken out of the solution and dried, followed by degreasing and further sintering in air atmosphere. By employing the method of supporting substituting elements in a dry body in place of kneading with raw ceramic materials, many substituting elements exist on the surface of the preform and substitution with elements arises on the surface of the preform during sintering to easily form a solid solution.

The ceramic carrier having a multitude of pores capable of directly supporting the catalyst on the surface of the substrate ceramic will be described below. As the catalyst ion to be supported typically has diameter of about 0.1 nm, the catalyst ions can be supported in the pores formed in the cordierite surface, provided that the pores are larger than 0.1 nm across. In order to keep the ceramic support strong enough, preferably the pores measure as little as possible across and are within 1000 times (100 nm) the diameter of the catalyst ion. The depth of the pores is set to not less than ½ (0.05 nm) the lateral size in order to retain the catalyst ion. In order to support a quantity of catalyst component comparable to that in the prior art (1.5 g/L) in the pores of this size, density of pores is set to 1×10¹¹/L or higher, preferably 1×10¹⁶/L or higher, and more preferably 1×10¹⁷/L or higher.

Specifically, pores can be formed in the ceramic support in a density not less than the value described above, when cordierite crystal that has one or more defect, either oxygen defect or lattice defect or both, per one unit crystal cell is included in the ceramic material in a concentration of 4×10⁻⁶% or higher, preferably 4×10⁻⁵% or higher, or when oxygen defect and/or lattice defect are included in a density of 4×10⁻⁸ per one unit crystal cell of cordierite or higher, preferably 4×10⁻⁷ or higher. Details of the pores and method for forming the same will be described below.

Among the pores formed in the ceramic surface, defects of the crystal lattice include oxygen defects and lattice defects (metal lattice vacancy and lattice strain), an oxygen defect is caused by deficiency of oxygen required to form the ceramic crystal lattice, and the catalyst component can be supported in the pores produced by the vacancy of oxygen. Lattice defect is caused when more oxygen is introduced than is required to form the ceramic crystal lattice, and the catalyst component can be supported in the pores produced by crystal lattice strain or metal lattice vacancy.

As described in Japanese Patent Application No. 2000-104994, oxygen defects can be formed in the crystal lattice by employing either of the following methods in the firing process after molding the ceramic material for forming cordierite that includes an Si source, an Al source and an Mg source: \mathring{1} to decrease the pressure of the firing atmosphere or make it a reducing atmosphere; \mathring{2} to use a compound, that does not include oxygen, for at least a part of the stock material, and fire the material in low oxygen concentration atmosphere thereby causing oxygen deficiency in the firing atmosphere or in the starting material; or \mathring{3} to substitute a part of at least one kind of the constituent elements of the ceramic material except for oxygen with an element that has a lower value of valence than that of the substituted element. Since the constituent elements turn to positive ions such as Si (4+), Al (3+) and Mg (2+) in the case of cordierite, substituting these elements with an element that has lower value of valence results in the shortage of positive charge of an amount corresponding to the difference in the value of valence between the substituted and substituting elements. Thus oxygen defects are formed by discharging 0 (2−) having negative charge thereby to maintain the electrical neutrality of the crystal lattice.

Lattice defects can be formed by \mathring{4} substituting a part of the constituent elements of the ceramic material except for oxygen with an element that has a higher value of valence than that of the substituted element, when at least a part of Si, Al and Mg that are constituent elements of cordierite is substituted with an element that has a higher value of valence than that of the substituted element, excessive positive charge is produced of an amount corresponding to the difference in the value of valence between the substituted and substituting elements and the amount of substitution. Thus a required amount of 0 (2−) having negative charge is taken in so as to maintain the electrical neutrality of the crystal lattice. The oxygen that has been introduced makes an obstacle for the cordierite crystal lattice to be formed in an orderly way, thereby forming lattice strain. Electrical neutrality may also be maintained by discharging a part of Si, Al and Mg so as to leave vacancies to be formed. In this case, a firing process is carried out in air, so that a sufficient supply of oxygen is provided. The defects described above are considered to be as small as several angstroms or less, and therefore cannot be counted when measuring the specific surface area by the common method such as the BET method that uses nitrogen molecules.

The number of oxygen defects and lattice defects is correlated to the amount of oxygen included in the cordierite. In order to support the catalyst component of the required quantity described above, the proportion of oxygen is controlled to be less than 47% by weight (oxygen defect) or higher than 48% by weight (lattice defect). When the proportion of oxygen becomes less than 47% by weight due to the formation of oxygen defects, the number of oxygen atoms included in one unit crystal cell of cordierite becomes less than 17.2, and the lattice constant of the b₀ axis of the cordierite crystal becomes less than 16.99. When the proportion of oxygen becomes higher than 48% by weight due to the formation of lattice defects, number of oxygen atoms included in one unit crystal cell of cordierite becomes larger than 17.6, and the lattice constant of the b₀ axis of the cordierite crystal becomes larger or less than 16.99.

Among the pores that can support the catalyst, microscopic cracks in the ceramic surface can be formed in a great number in at least one of an amorphous phase and a crystal phase by applying thermal shock or acoustic shock waves to the cordierite. For the cordierite structure to have sufficient strength, it is better to make the cracks smaller, about 100 nm or less in width, and preferably about 10 nm or less.

Thermal shock is usually applied by heating the cordierite structure and then quenching it. The thermal shock may also be applied after the amorphous phase and the crystal phase have been formed in the cordierite structure, by either of a method of heating to a predetermined temperature and then quenching a cordierite honeycomb structure formed by sintering process after molding and degreasing the ceramic material for forming cordierite that includes an Si source, an Al source and an Mg source, or quenching from a predetermined temperature in the process of cooling the sintered honeycomb structure. Thermal shock for generating cracks can be produced when the difference between the heating temperature and the temperature after quenching (impact temperature difference) is about 80° C. or higher, with the cracks becoming larger as the impact temperature difference becomes larger. However, as cracks that are too large make it difficult to maintain the shape of the honeycomb structure, the impact temperature difference should usually be not higher than about 900° C.

Amorphous phase of the cordierite exists in the form of layers around the crystal phase. When thermal shock is applied by heating the cordierite and then quenching, thermal stress is generated in the interface between the amorphous phase and the crystal phase, the magnitude of the thermal stress being determined by the difference in the thermal expansion coefficient between the amorphous phase and the crystal phase and the impact temperature difference. Microscopic cracks are generated when the amorphous phase or the crystal phase cannot withstand the thermal stress. The number of microscopic cracks to be generated can be controlled by means of the proportion of the amorphous phase. The number of cracks can be increased by adding an increased amount of a trace component of the material that is thought to contribute to the formation of the amorphous phase (alkali metal, alkali earth metal, etc.). Acoustic shock waves such as ultrasound or vibration may also be used instead of thermal shock. Microscopic cracks are generated when a weaker portion of the cordierite structure cannot withstand the energy of acoustic shock waves. In this case, the number of microscopic cracks to be generated can be controlled by regulating the energy of the acoustic shock wave.

Among the pores that can support the catalyst, deficiencies of the constituent elements of the ceramic material are generated by eluting the constituent elements of cordierite or impurity by a liquid phase process. For example, element deficiency can be generated by eluting metallic elements such as Mg or Al included in the cordierite crystal, alkali metal element or alkali earth element included in the amorphous phase, or the amorphous phase itself into high-temperature, high-pressure water, supercritical water, alkali solution or other solution, so that the element deficiencies make microscopic pores that support catalyst. Deficiencies can also be formed chemically or physically in the gas phase process. For example, dry etching may be used as a chemical process, and sputter etching can be employed as a physical process, where the number of pores generated can be controlled by regulating the duration of etching or the energy supply.

In accordance with the method described above, a ceramic carrier was prepared by using cordierite as the substrate ceramic and substituting 5 to 20% of Al which is the constituent element with W. Starting materials were prepared by using a cordierite material comprising talc, kaolin and alumina and subtracting 5 to 20% of the Al source from the cordierite material, and were kneaded and formed into honeycomb using a conventional method, and then dried. The dried preform was immersed in a solution of WO₃, a compound of W used as the substituting element. The preform having much WO₃ on the surface of the honeycomb preform was taken out of the solution and dried. After degreasing at 900° C. in air, the honeycomb structure was sintered in air at a heating rate of 5 to 75° C./hr and held at a temperature of 1300 to 1390° C.

The structure of the resulting ceramic carrier was examined by X-ray diffraction. The structure of the cordierite phase varies as a result of the substitution of Al with W and, thus, a solid solution exists. Actually, peaks of WO₃ and MgWO₄ as phases other than cordierite were confirmed. There is a relationship between the content of phases other than cordierite (WO₃ and MgWO₄) and the heating rate. It was confirmed that a lower heating rate (longer reaction time) leads to much W as the substituting element to be incorporated into cordierite crystals.

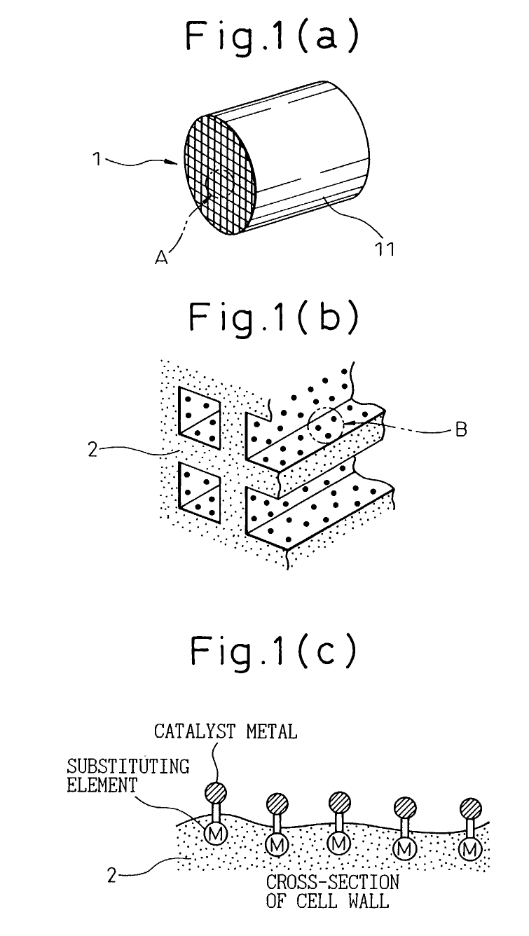

The ceramic catalyst body of the present invention is made by directly supporting the catalyst metal on this ceramic carrier. As the catalyst metal, for example, noble metal elements such as Pt, Rh, Pd, Ir, Au, Ag and Ru are preferably used and at least one noble metal selected from these noble metals can be supported. Metals other than these noble metals can also be used as promoters. FIG. 1(a) to FIG. 1(c) show a catalyst-loaded structure of the ceramic catalyst body 1 having a honeycomb structure of the present invention. As shown in FIG. 1(a), a honeycomb ceramic carrier 11 has a number of cells that are separated from each other in the direction of the gas flow and, as shown in FIG. 1(b), a number of catalyst metal atoms (indicated by the symbol ● in the drawing) are supported on the surface of the cell wall 2. FIG. 1(c) is an enlarged view of a cross-section of the cell wall 2 and each catalyst metal atom is directly supported by chemically bonding with the substituting element M which exists near the surface of the cell wall 2.

In the present invention, in case of supporting the catalyst metal on the ceramic carrier, a compound containing no chlorine in the composition is used as a starting material of the metal catalyst. Preferably, the electronegativity of an element or a group produced when thermally decomposed is lower than the electronegativity (3.0) of Cl. Specifically, as the compound containing chlorine in the composition, an ammine complex salt, a nitro complex salt, a nitroammine complex salt, a tetraammine complex salt, a nitrate salt or an acetate salt of a desired catalyst metal is preferably used. Specific examples of these compounds include dinitrodiammine platinum, hexaammine platinum hydroxide salt, tetraammine platinum hydroxide salt, rhodium nitrate, and rhodium acetate.

To deposit the catalyst metal on the ceramic carrier, a conventional method is used. For example, a solution is prepared by dissolving a compound of the catalyst metal, which contains no chlorine, into a solvent such as water or alcohol and the ceramic carrier is impregnated with this solution and is then dried and sintered in air atmosphere. Sintering temperature is required only to be not lower than the temperature at which the compound of the catalyst metal is thermally decomposed, and may be set in accordance to such factors as the catalyst metal and the compound to be used. It is preferable to sinter at a lower temperature as it makes the metal particle size produced by thermal decomposition smaller, and causes the metal particles highly dispersed over the support. Specifically, the firing temperature is set in a range from 300 to 800° C. and is appropriately selected according to the kind of the catalyst metal and compound.

When two or more kinds of catalyst metals are used in combination, the ceramic preform may be immersed in a solution that includes the plurality of catalyst metals. In case Pt and Rh are used as the catalyst metals, for example, the preform may be immersed in a solution that includes the compounds of these metals, and is then dried and sintered in air atmosphere.

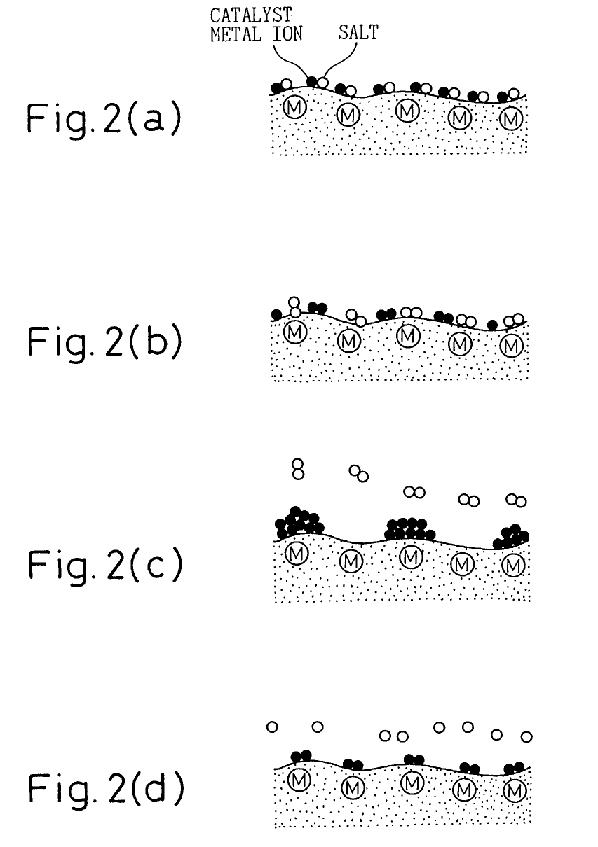

With respect to the ceramic catalyst body thus obtained, the quantity of the catalyst supported increases and the catalyst performance is improved as compared with the case of using the compound containing chlorine as the starting material. This fact will be explained with reference to FIG. 2(a) to FIG. 2(d). FIG. 2(a) is a schematic view showing the state of the cell wall 2 after impregnating with a catalyst solution and drying, and catalyst metal ions and salts contained in the catalyst solution are adsorbed on the surface of the cell wall 2. When using, as the starting material of the catalyst component, a compound containing chlorine (for example, hexachloroplatinic acid, hexaammine platinum tetrachloride, dichlorodiammine platinum, platinic chloride, platinous chloride, tetraammine platinum dichloride, rhodium chloride or the like), salts are liable to be remained on the catalyst surface after thermally decomposed by sintering in air atmosphere, as shown in FIG. 2(b). It is supposed that support of the catalyst metal is suppressed because a chlorine salt is adsorbed on the substituting element due to a difference in electronegativity. In case the noble metal catalyst Pt is supported on the substituting element W, a difference in electronegativity (1.3) between W and Cl is larger than a difference in electronegativity (0.8) between W and Pt and, therefore, Cl is strongly attracted to W as compared with Pt. In case of cleaning NOx in the exhaust gas, the catalyst surface is acidified when chlorine remains and it becomes difficult to adsorb NOx.

To remove an influence of chlorine, there is proposed a method of forcibly removing chlorine from the catalyst surface by subjecting it to a treatment of raising the sintering temperature (for example, to about 800° C.), as shown in FIG. 2(c). However, when the sintering temperature is high, metal atoms cause grain growth during sintering. As a result, catalyst particles having a large particle size are bonded with the substituting element M, thus making it impossible to sufficiently enhance the catalyst performance by the quantity of the catalyst supported. It is also possible to forcibly remove chlorine from the catalyst surface by subjecting to a treatment such as hydrogen reduction, however, the number of processes increases disadvantageously.

In the present invention, as a metal compound containing no chlorine in the composition is used as the starting material, chlorine does not remain on the catalyst surface, as shown in FIG. 2(d). As the catalyst does not contain an element or group having large electronegativity, like chlorine, it is less likely to be attracted electrically to the substituting element M. Furthermore, as the noble metal catalyst has a function of directly decomposing NOx into N₂ and O₂, NOx is decomposed by the noble metal catalyst even when bonded with the substituting element it the starting material contains NOx. As a result, the catalyst component is supported on the substituting element M in the state of metal atoms and fine metal particles, and thus the catalyst performance is improved. Moreover, since adsorption of NOx is not suppressed, the cleaning ability of the catalyst can be exerted more effectively. The catalyst metal is less likely to cause grain growth because the step of removing chlorine by firing at high temperature is not required. Consequently, the noble metal catalyst can be highly dispersed and high catalyst performance can be obtained from a small quantity of the catalyst.

To obtain the effect described above, the smaller the content of chlorine in the solution of the above metal compound, the better. Specifically, the chlorine content is lower than 14.8 g/L corresponding to the content of chlorine in a conventional hexachloroplatinic acid (0.07 mol/L) solution, preferably lower than 350 mg/L corresponding to the content of chlorine in a commercially available tetraammine hydroxide salt solution, and more preferably lower than 0.9 mg/L corresponding to the residual chlorine content in tap water.

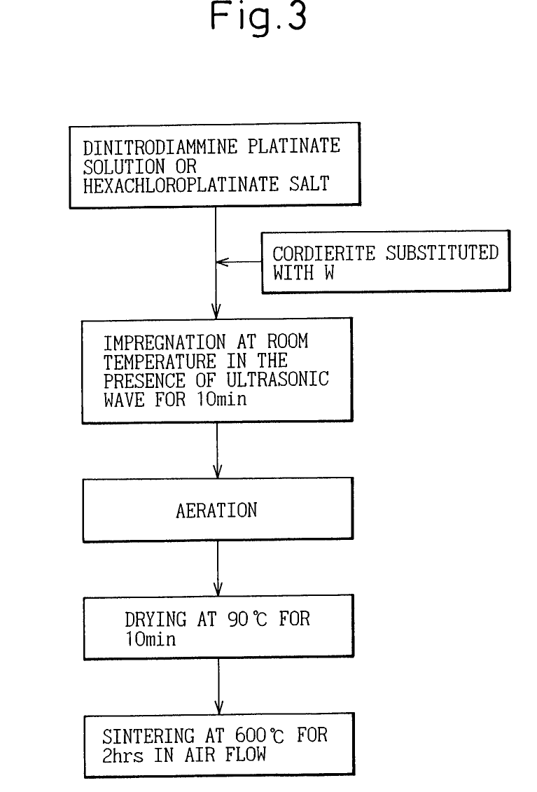

Then, a ceramic catalyst body of the present invention was obtained by supporting the noble metal catalyst Pt on the ceramic carrier (cordierite substituted with W) made by the above method. In accordance with the step shown in FIG. 3, an aqueous solution containing 0.07 mol/L of dinitrodiammine platinum as a Pt compound containing no chlorine in the composition was prepared and a ceramic carrier (measuring Φ15 mm×L10 mm) was immersed in 50 ml of the aqueous solution. After standing for 10 minutes while applying ultrasonic waves, the ceramic carrier was taken out from the aqueous dinitrodiammine platinum solution and the solution remained in the opening was removed by aeration. This ceramic carrier was put in a constant-temperature bath maintained at 90° C. and allowed to stand for 10 minutes, thereby to vaporize the solvent. The ceramic carrier taken out from the constant-temperature bath was sintered in an air flow at 600° C. for 2 hours, thereby baking the catalyst metal on the carrier (the Example).

In the same manner as described above, except that a Pt compound containing chlorine, as hexachloroplatinate salt, was used as a starting material, a ceramic catalyst body was obtained (the Comparative Example) for comparison. The content of chlorine in the aqueous solution of hexachloroplatinic acid was 14.8 g/L and chlorine was not detected from the aqueous solution of dinitrodiammine platinum. To each of the resulting ceramic catalyst bodies of the Example and the Comparative Example, a reaction gas of 500 ppm C₃H₆+5% O₂ (He base) was fed at a flow velocity SV=10000 h⁻¹ and the temperature was varied in a range from 100 to 250° C. every 25° C. The reaction rate of C₃H₆ was determined. The results are shown in FIG. 2. The gas quantitative analysis was conducted by gas chromatography.

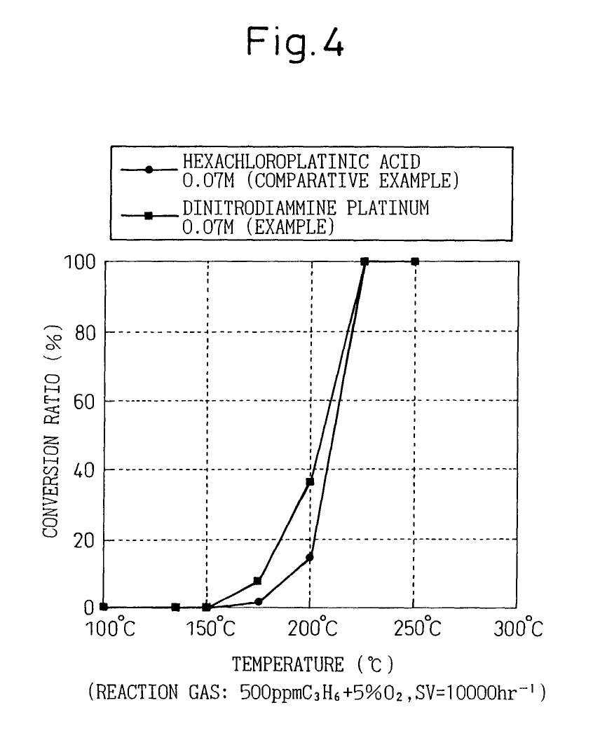

As is apparent from FIG. 4, the ceramic catalyst body of Example using a starting material containing no chlorine exhibits a higher conversion ratio at low temperature as compared with the ceramic catalyst body of Comparative Example using a starting material containing chlorine. The quantity of the noble metal (Pt) supported on each ceramic catalyst body was measured by EPMA. The results are shown in Table 1. An average value was calculated from 20 measuring points per one ceramic catalyst body and was taken as the quantity of Pt supported. As is apparent from the results shown in Table 1, the ceramic catalyst body of the Example using a starting material containing no chlorine exhibits a larger quantity of Pt supported as compared with the ceramic catalyst body of the Comparative Example using a starting material containing chlorine, and thus a difference in starting material exerts a large influence on the quantity of Pt supported, then on the catalyst performance.

TABLE 1

| | Comparative Example | Example |
|---|---|---|
| Quantity of Pt | Hexachloroplatinic | Dinitrodiammine |
| supported | acid | platinum |
| (gL⁻¹) | 1.12 | 1.97 |

With respect to the resulting ceramic catalyst bodies of the Example and the Comparative Example, a change in binding energy of W before and after supporting of Pt. As a result, plural peaks that are seemed to be generated by an influence of supporting of Pt, were confirmed, in addition to the peak of WO₃, and the existence of a bond sharing free electrons between substituted W and Pt was confirmed.

As described above, a ceramic catalyst body supported directly with the catalyst metal can be obtained by using the ceramic body wherein a portion of constituent elements of the substrate ceramic is substituted of the present invention without forming a coating layer made of γ-alumina. Since the resulting ceramic catalyst body is preferably used as an automobile exhaust gas purifying catalyst and requires no coating layer, it is effective to reduce the heat capacity, coefficient of heat expansion and pressure loss.

In the ceramic catalyst body of the present invention, the catalyst metal is supported by means of chemical bonding. Therefore, bonding of the ceramic body with the catalyst component becomes strong as compared with the method of physically supporting it on vacancies, thus resulting in high effect of suppressing thermal deterioration caused by agglomeration of catalyst components as a result of the movement due to thermal vibration. Moreover, since a compound containing no chlorine was used as the starting material of the catalyst metal, the residual chlorine causes neither suppression of supporting of the catalyst metal, nor lowering of the adsorption capacity of NOx in the exhaust gas. Also when the catalyst metal is highly dispersed by lowering the sintering temperature, the maximum catalyst performance can be achieved.

What is claimed is:

1. A ceramic catalyst body comprising a ceramic carrier capable of supporting a catalyst component directly on the surface of a substrate ceramic and a catalyst supported on the ceramic carrier, wherein said catalyst component is made of a compound containing no chlorine in the composition as a starting material.

2. The ceramic catalyst body according to claim 1, wherein said compound is an ammine complex salt, a nitro complex salt, a nitroammine complex salt, a tetraammine complex salt, a nitrate salt or an acetate salt.

3. The ceramic catalyst body according to claim 1, wherein said catalyst component is a noble metal.

4. The ceramic catalyst body according to claim 1, wherein said catalyst component is supported by impregnating the ceramic carrier with a solution of the compound and firing.

5. The ceramic catalyst body according to claim 4, wherein the content of chlorine in the solution of the compound is lower than 14.8 g/L.

6. The ceramic catalyst body according to claim 1, wherein one or more of the elements that constitute the substrate ceramic is substituted with an element other than the constituent element, and said ceramic carrier is capable of supporting the catalyst component directly on the substituting element.

7. The ceramic catalyst body according to claim 6, wherein said catalyst component is supported on the substituting element by means of chemical bonding.

8. The ceramic catalyst body according to claim 6, wherein said substituting element is one or more elements having a d or f orbit in the electron orbits thereof.

9. The ceramic catalyst according to claim 1, wherein said ceramic carrier has a multitude of pores capable of directly supporting the catalyst on the surface of the substrate ceramic so that the catalyst component can be supported directly in the pores.

10. The ceramic catalyst according to claim 9, wherein the pores comprise at least one kind selected from the group consisting of defects in the ceramic crystal lattice, microscopic cracks in the ceramic surface and defects in the elements which constitute the ceramic.

11. The ceramic catalyst according to claim 10, wherein the microscopic cracks measure 100 nm or less in width.

12. The ceramic catalyst according to claim 10, wherein the pores have diameters or widths 1,000 times the diameter of the catalyst ion to be supported therein or smaller, and the density of pores is 1×10¹¹/L or higher.

13. The ceramic catalyst according to claim 10, wherein the substrate ceramic includes cordierite as the main component, and the pores comprise defects formed by substituting a part of the constituent elements of the cordierite with metal element having different value of valence.

14. The ceramic catalyst according to claim 13, wherein the defects comprise at least one kind, oxygen defect or lattice defect, and the proportion of cordierite crystal containing at least one defect in a unit crystal lattice of cordierite is set to 4×10⁻⁶% or higher.
